(19) United States
(12) Patent Application Publication
(10) Pub. No.: US 2025/0002815 A1
(43) Pub. Date: Jan. 2, 2025

(54) LABSA FREE DISHWASH CLEANSING CONCENTRATE

(71) Applicant: GALAXY SURFACTANTS LTD., Navi Mumbai (IN)

(72) Inventors: Sagar Anil Trailokya, New Panvel (IN); Vaishali Amol Jumde, Kamothe (IN); Harshal Shinde, Mumbai (IN)

(73) Assignee: GALAXY SURFACTANTS LTD., Navi Mumbai (IN)

(21) Appl. No.: 18/756,684

(22) Filed: Jun. 27, 2024

(30) Foreign Application Priority Data
Jun. 27, 2023 (IN) 202321043183

(51) Int. Cl. C11D 1/94; C11D 1/14; C11D 1/29; C11D 1/75; C11D 1/90; C11D 3/12; C11D 3/20; C11D 3/34; C11D 3/37

(52) U.S. Cl. CPC C11D 1/94; C11D 3/122; C11D 3/2068; C11D 3/3481; C11D 3/3776; C11D 1/146; C11D 1/29; C11D 1/75; C11D 1/90

(57) ABSTRACT

A concentrated dish wash composition is disclosed. The concentrated composition is based on an Anionic and Amphoteric surfactant system with other components, where ratio of Anionic: Amphoteric Surfactants is 1:1 and 1.5:1. The concentrate on dilution with water affords a low active (<10%) viscous dish wash formula ranging viscosity from 2500 cps to 10000 cps. Performance of diluted viscous liquid dish wash is superior to other substantially high active (>15%) formulations. The dish wash concentrate is free of LABSA, quickly dissolves in water (<10 seconds) provides superior performance and is gentle to skin.

### FIELD OF INVENTION

The present invention is directed towards dish wash composition. More particularly, the invention relates to a concentrated dish wash composition that upon dilution with water results with composition having higher viscosity and superior performance.

### BACKGROUND AND PRIOR ART

The concept of do it yourself (D.I.Y.), by converting concentrated composition into an end use composition is around for past few years. The emergence of this D.I.Y. concept is logical due to on-going complications of global warming.

Today's consumers are also well educated and want to avoid the use of products harmful to human health, harmful to the environment and are willing to contribute to the nature by all possible means such as reducing the carbon footprint, saving the precious natural fuels etc.

Typical dish wash composition comprises about 15% to 20% of actives like surfactants and other additives and the rest 80% to 90% is water. Practically, the dish wash compositions that are being transported across the different places in the world contain majority amount of water and hence, ending up consumption of precious fossil fuels for transporting very commonly available water. Hence, formulating a concentrated composition with high active and further dilution of same by consumer saves tremendous amount of energy and water by eliminating 60 to 80% by weight of water in concentrated dish wash composition. Additionally, consumers look at the viscosity of a product as one of the crucial factors for its performance. Therefore, a product with higher viscosity would perform better than a product having lower viscosity, as low viscosity products may comprise more water and therefore the consumers have the perception of poor performance.

There has been an attempt to formulate a concentrated dish wash composition and efforts are made to disclose such concentrated dish wash composition.

U.S. Pat. No. 8,895,492B2 relates to a dilutable aqueous liquid cleaning composition, particularly a dishwashing liquid, which comprises multiple surfactants. However, it discloses the use of metal salts of linear alkyl benzene sulfonate as one of the surfactants components in preparation of liquid cleaning compositions. Linear alkyl benzene sulfonate-based surfactants are manufactured by consuming petrochemicals as raw material. US '492 does teach few examples that are free from linear alkyl benzene sulfonate based components however such composition contain viscosity boosting agents.

JP6205123B2 teaches the preparation of a concentrated liquid detergent containing about 40 to 99% by weight of linear alkylbenzene sulfonic acid or salts in two phases (a first phase and a second phase) and which upon dilution provides a uniform single phase formulation. However, such different phase concentrated compositions are at times difficult to handle.

U.S. Pat. No. 10,253,277B2 teaches the novel cleaning concentrated cleansing compositions that attempts to replace cocamide diethanolamine by coupling agents, however such compositions are also based on alkyl benzene sulphonates. Further, cocamide diethanolamine have serious concerns with respect to environment and health of human beings.

Hence, prior art discloses a variety of concentrated dish wash composition but there lies a problem for formulating a concentrated dish wash composition that is free from petrochemical based surfactants like alkyl benzene sulphonate (LABSA).

Such composition demands requirement of heating step while manufacturing process, usage of high-cost ingredients and usage of ingredients that causes adverse impact to environment. Further, there also lies problems with respect to performance of compositions. Often the concentrate dish wash composition when diluted with water results into poor performance and undesired properties such as decrease in the ease rinsability, free flowability from container during the dish washing process, effect of hard water on performance of diluted composition, reduction in viscosity—as composition becomes watery after dilution, difficulty in dissolution usually take hours to dissolve to provide a useable product.

Further, U.S. Pat. No. 9,862,913 discloses an aqueous, acidic, self-preserving, liquid cleaning composition, typically a dishwashing liquid. U.S. Pat. No. 9,862,913 does teach the concentrated dish wash compositions that are free of linear alkyl benzene sulphonate, however such concentrates comprise additional viscosity modifying agents. Further the surface-active agent present are as high as up to 55% of composition that comprises majority of anionic surfactants.

Therefore, there is a need for formulating a dish wash composition that is better performing as well as have desired viscosity. There also remains a need for a hand dishwash composition which has lower actives but has good viscosity without usage of viscosity building/modifying agents or polymer. Also, there lies a challenge to produce a high concentrated hand dish wash composition with lower viscosities that will make such concentrated products flowable and at the same time, such concentrated products, when diluted, result into increase in the viscosity and provide better performance. There is also need for formulating a dishwash composition that is mild and gentle on hands when used during dishwash operation.

Surprisingly, the inventors of present invention have found ways of overcoming the aforesaid problems by developing a concentrated dish wash composition that have higher actives and has low viscosity and upon dilution results in increase in viscosity yet providing superior performance.

### OBJECTIVES OF THE INVENTION

It is an objective of the present invention to create a concentrated dish wash composition which upon dilution results into increase in viscosity without compromise in performance.

Yet another objective of the present invention is to provide a concentrated dish wash composition that is free from petrochemical derived ingredients.

Yet another objective of the present invention is to provide a concentrated dish wash composition that provides high performance even at lower concertation of active ingredients.

Yet another objective of the present invention is to save on the natural resources by eliminating the transportation of locally available components like water.

Yet another objective of present invention is to reduce the burning of fossil fuels and eliminate the release of greenhouse gases and contribute to reduce the global warming.

Yet another objective of present invention is to create concentrate formulations containing CAPB: LES surfactants in the ratio of 1:1 to 1:1.5.

### SUMMARY OF INVENTION

According to one aspect the present invention provides a concentrated dish wash composition comprising:
a) 15% to 40% by weight of the composition, an anionic surfactant;
b) 5% to 25% by weight of the composition, at least one amphoteric surfactant;
c) 2% to 8% by weight of the composition, at least one metal salt and preservative; and
d) water,
wherein, the viscosity of the concentrated dish wash composition ranges from 1000 to 2000 mPas, measured at temperature 25° C., which upon 4 to 6 times dilution with water increases to a range of 2500 to 10000 mPas measured at temperature 25° C.

The above-described features and the advantages of the present disclosures will be appreciated and understood by those skilled in the art from the ‘detailed descriptions’ and ‘the claims’.

### BRIEF DESCRIPTION OF FIGURES

FIG. 1: Depicts the comparative assessment of the 4 times and 5 times diluted composition of the present invention with comparative marketed composition.

FIG. 2: Depicts the mildness study of 4 times diluted composition of the present invention with composition of US '700.

### DETAILED DESCRIPTION OF THE INVENTION

The concentrated composition of present invention is advantageously free from commonly used alkyl benzene sulphonates and comprises 15% to 40% by weight of anionic surfactants and 10% to 25% by weight of the composition, at least one amphoteric surfactant. Typically, the commonly used surfactants like alkyl benzene sulphonates are obtained from petrochemical sources.

Most importantly, the surfactant composition of the present invention upon 4 to 6 times dilution builds desired viscosity without compromising in the performance. This enables to transport the composition in a concentrated form and hence, contribute in a great way for carbon footprint reduction.

Moreover, the concentrated composition of the present invention is intended to be diluted by consumers at home. By being diluted with externally added water in a reusable container, the consumption of plastic waste can be reduced further.

Terms “concentrated dish wash composition” or “dish wash composition” or “dish wash concentrate” can used interchangeably in the specification and refers to the composition of present invention.

Terms “diluted composition” or “diluted dish wash composition” can be used interchangeably in the specification and refers to the composition obtained after dilution of concentrated dish wash composition.

Reference to weight % or % by weight in the specification are on an active basis in the total composition.

Most importantly, the surfactant composition of the present invention upon 4 to 6 times dilution builds desired viscosity without compromising in the performance.

The inventors of the present invention have achieved the synergy of surfactants, desired viscosity of concentrated and diluted dish wash liquid and therefore have created a unique product. Even after high dilution with water i.e. 6 times dilution, ready to use liquid dish wash is viscous enough to satisfy consumer need which is more than ˜2000 cps. at 25 deg. C.

Concentrated system is pumpable, yet quickly miscible in water (<10 sec.) when it is in use for diluted dish washing. Concentrated dish wash upon 6 times dilution with water, delivers enough viscous (>2000 cps), pourable, superior performing, stable homogenized, transparent liquid dish wash, which is free from petrochemical source, and optionally uses viscosity modifier polymer etc.

In another aspect the invention relates to novel cleaning composition such as dish wash cleanser (with 7% active) suitable to use in hard water and low temperature. The present invention further also comprises process of concentrate dish wash liquid and to further prepare ready to use liquid dish wash using DIY concept.

The concentrated dish wash composition of the present invention comprises of:
a) 15% to 40% by weight of the composition, an anionic surfactant;
b) 5% to 25% by weight of the composition, at least one amphoteric surfactant;
c) 2% to 8% by weight of the composition, at least one metal salt and a preservative; and
d) water,
wherein, the viscosity of the concentrated dish wash composition ranges from 1000 to 2000 mPas measured at temperature 25° C. which upon 4 to 6, preferably 5 times dilution with water increases to a range of 2500 to 10000 mPas measured at temperature 25° C.

The dishwash compositions available in the market usually comprises higher amount of anionic surfactants and lower amount of other surfactants. However, the present invention comprises lower anionic surfactants and comparatively higher amphoteric surfactants than what is typically available in market. Such stoichiometry of anionic and amphoteric surfactants surprisingly, provides a concentrated surfactant composition that is flowable at room temperature and further upon dilution, such concentrate composition results into increase in viscosity of final diluted dishwash composition.

Preferably the ratio of anionic to amphoteric surfactant is 1:2. More preferably the ratio of anionic to amphoteric surfactant is 1:1. Most preferable the ratio of anionic to amphoteric surfactant is 1:1.5.

Preferably the concentrated dish wash composition has viscosity, measured at 25° C., of about 500 to 2500 cps. More preferably the viscosity of concentrated dish wash composition ranges from 750 to 2250 cps. Most preferably, the viscosity of the concentrated dishwash composition ranges from 1000 to 2000 cps.

The concentrated dish was composition can be preferably diluted 3 to 6 times with water. Most preferably the concentrated dish wash composition can be diluted 4 to 5 times with water.

Preferably the viscosity, measured at 25° C., of diluted dish wash composition ranges from 2500 to 10000 cps. The increase in viscosity upon dilution brings ease in use, also enhances aesthetics of the final compositions and meets consumer's needs with respect to product specification.

The concentrated composition of present invention comprises 15% to 40% by weight of anionic surfactants. The suitable anionic surfactants incorporated in the concentrated composition are fatty acid ethoxylate sulfate such as sodium laureth sulfate with 1-3 moles of ethylene oxide.

The concentrated dish wash composition herein comprises 5% to 25% by weight of an additional amphoteric surfactants. The suitable amphoteric surfactants used in concentrated composition of present invention are alkylamidopropyl betaine like cocoamidopropyl betaine, laurylamidopropyl betaine and mixture thereof. Concentrated composition may also include amine oxide based amphoteric surfactants. Suitable amphoteric surfactants include lauramidopropylamine oxide (LAPAO) and lauryl amine oxide (LAO) and mixture thereof. Suitably at least two amphoteric surfactants are present the amount of alkylamidopropyl betains ranges from 10% to 20% by weight and amine oxide is present in the range of 0.1% to 5% by weight.

In an embodiment the surfactant composition consists of at least one anionic surfactant and at least one amphoteric surfactant, wherein the weight ratio of total anionic surfactants to amphoteric surfactants is 1:1 to 1.5:1.

The concentrated dish wash composition comprises divalent metal salt. In some embodiments, at least one divalent metal salt comprises magnesium sulfate. In some embodiments, at least one divalent metal salt and at least one preservative is present in an amount of is present in an amount of 2 to 8% by weight, based on the weight of the composition.

The composition of the present invention comprises other ingredients selected from a polymer, a humectant, a preservative and a hydrotrope.

Other ingredients, that may be included to support achievement of the desired viscosity profile of the compositions upon dilution, are polymer, humectant, preservative.

The compositions can be formulated as cleaning liquids such as hand dishwashing detergents, liquid hand soaps, shampoos, and body washes, etc. The compositions also present an eco-friendly option for liquid cleaning detergents. Particularly preferred embodiments are directed to hand dishwashing detergents.

The composition can be sold in a smaller pack, since it is in concentrated form. As a result, transportation energy and packaging materials can be reduced. When the concentrated composition is diluted by consumers at home, for example by being diluted with additional water in a reusable container, the consumption of plastic waste can be further reduced.

Suitably the hydrotrope is selected from the group comprising of sodium xylene sulfonate (SXS), cumene sulfonate, glycerol ethers, urea, sodium N-octyl sulfoitaconate diester.

Suitably the polymer is selected from the group comprising of Acrylic polymer or natural polymer such as polyquat 7 and xanthan gum respectively.

Suitably the humectant is selected from group comprising of propylene glycol, glycerine, dipropylene glycol, butylene glycol.

Suitably the preservative is selected from the group comprising of phenol, Methylchloroisothiazolinone, phenoxyethanol, sodium benzoate, parabens.

Suitably the concentrated composition is diluted with water by the consumer before the use. The concentrated composition can be diluted with water to a particular amount.

Typically, the dilution value is within a dilution range of four to six times the volume of the undiluted composition.

The concentrated composition of the present invention is intended to be diluted by consumers at home. By diluting with externally added water and shaking for less than 10 seconds in a reusable container forms a homogeneous, single phase ready to use composition. Such concentrated composition saves packaging cost and reduces packaging waste and recycling. When consumers use 20% of this innovative concentrate, they save transportation 80% water and directly contribute towards sustainability and cleaner environment as transportation of water from one place to other place (till it reaches to consumer) involves huge fuel and directly CO₂ emission.

### Examples

The present invention is now described by way of non-limiting illustrative examples. The details of the invention provided in the following examples are given by the way of illustration only and should not be construed to limit the scope of the present invention.

The personal care ingredients (mentioned below) are procured from generic sources. The formulated products are identified by their trade-names and are sourced from the manufacturers or their distributors.

LES, CAPB, LAO, Phenoxy ethanol, Polyquaternium-7 are procured from Galaxy Surfactants Ltd. Kathon CG (Methylchloroisothiazolinone) is procured from Dupont.

Fragrance is procured from Leo fragrances and colour is procured from Neelikon Food Dyes and Chemicals Ltd.

CAPB refers to cocamidopropyl betaine, LES refers to sodium laureth sulphate.

In the other embodiment, the inventors of the present invention have found an environment friendly LABSA free dish was concentrate composition with specific ratio of anionic and amphoteric surfactants (1:1 to 1.5:1); without compromising in the performance and yet achieving the desired properties.

### Methods:

Viscosity is measured using a Brookfield LVDV II, Viscometer using spindle 64 at 25° C.

TPC is measured as per the method below:

500 ppm solution of dish wash liquid stirred for 1 minute to create foaming. Soiled steel plates were washed with the help of scotch brite in the above solution till all foam disappeared. Number of plates required to disappear the foam, are the total plate count (TPC). The higher the TPC, better the dish wash liquid in performance.

Foam volume is measured as per the method below:

Cylinder shake method as per BIS used to create foam for 0.25% solution. 50 ml solution Shaked in cylinder with the help of hand for 10 shakes at 25° C. Volume of foam was measured in terms of ml. Higher the foam volume, better the dish wash liquid.

### Example 1: Dish Wash Concentrates with Varying Ratio

Dish wash concentrate compositions were prepared with varying ratio of anionic and amphoteric surfactants.

Example 1a demonstrates the ratio of LES: CAPB of 1.5:1, while example 1c and 1d and 1b demonstrates that ratio of LES: CAPB of 3:1, 5:1 and 1:1 respectively.

### Process of Manufacturing of Dish Wash Concentrate:

All the surfactant-based ingredients were weighed and mixed. After mixing other ingredients like salt, chelating agent, preservatives, colour and fragrance were added, and mixing was continued. After the formation of homogeneous mixture, the pH and viscosity of concentrate were measured.

TABLE 1
Dish wash concentrates with varying ratio.

| | | Example 1a | | Example 1c - | Example 1d - |
|---|---|---|---|---|---|
| | | (inventive | | Comparative | Comparative |
| | % | composition) | Example 1b - | Example | Example |
| | Active | LES:CAPB | LES:CAPB | LES:CAPB | LES:CAPB |
| Ingredient | matter | 1.5:1 | 1:1 | 3:1 | 5:1 |
| Galaxy LES | 70% AM | 20.73 | 15 | 25.99 | 28.88 |
| Galaxy CAPB SB | 29% AM | 13.92 | 15 | 8.66 | 5.78 |
| Galaxy LAO | 29% AM | 0.85 | 0.85 | 0.85 | 0.85 |
| Chelating agent | — | 1 | 1 | 1 | 1 |
| Preservative | — | 2.5 | 2.5 | 2.5 | 2.5 |
| Salt | — | 4 | 4 | 4 | 4 |
| PQ 7 | — | 3 | 3 | 3 | 3 |
| Humectant | — | 3.5 | 3.5 | 3.5 | 3.5 |
| Fragrance | — | 1 | 1 | 1 | 1 |
| Colour | — | q.s. | q.s. | q.s. | q.s. |
| Water | — | q.s. to 100 | q.s. to 100 | q.s. to 100 | q.s. to 100 |
| TOTAL | | | | | |

Active matter

| | | | | |
|---|---|---|---|---|
| 25% dilution | 8.8% | 7.7% | 8.8% | 8.8% |
| 20% dilution | 7.1% | 6.17% | 7.1% | 7.1% |

The viscosities of concentrates were measured and further these concentrates were diluted at different dilution levels. After dilution, the composition of Example 1a surprisingly showed an increase in viscosity from 1278 cps to 8000 cps (at 25% or 4 times dilution level). On the other hand, the compositions of Example 1c and 1d showed acute drop in viscosity after dilution of concentrate composition.

TABLE 2
Viscosity and Performance of diluted
compositions of examples in table 1.

| | Example 1a- | Example 1b- | Example 1c- | Example 1d- |
|---|---|---|---|---|
| | Inventive | Inventive | Comparative | Comparative |
| | Composition | Composition | Example | Example |
| Dilutions | Viscosity in cps | | | |
| Concentrate | 1278 | 1388 | 1375 | 1320 |
| 25% dilution | 8000 | 7258 | 654 | 60.5 |
| 20% dilution | 3029 | 3329 | 39 | 10 |
| 19% dilution | 2000 | 2863 | 28 | 10 |
| 18% dilution | 1000 | 1520 | 16 | 9 |
| 17% dilution | 500 | 907 | 14 | 7 |
| LABSA Free | Concentrate | Concentrate | Concentrate | Concentrate |
| GSL Dish wash | of Example | of Example | of Example | of Example |
| Concentrate | 1a | 1b | 1c | 1d |
| pH | 8.31 | 7.31 | 8.05 | 8.45 |
| Total plate | 12 | 12 | 12 | 12 |
| count (TPC) | | | | |
| Foam | 130 | 130 | 130 | 130 |
| volume (FV) | | | | |

Also from above table, it is observed that the performance of diluted composition is at par with those of composition of examples 1c and 1d. The anionic surfactants active contents in example 1a are much lower than those in example 1c and 1d, despite that the performance with respect to total plate count (TPC) and foam volume (FV) was comparable with comparative examples 1c and 1d.

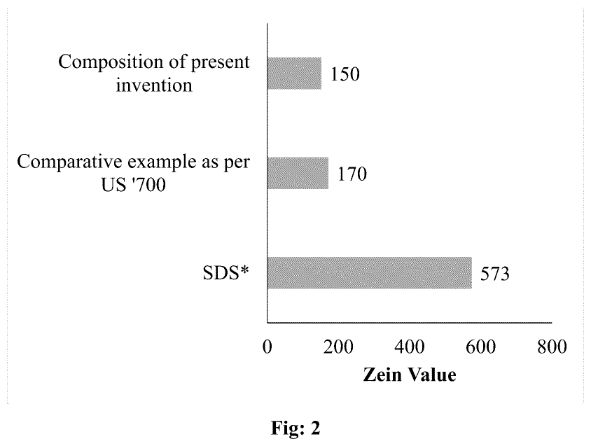

FIG. 2 depicts the performance of the comparative marketed product with that of present invention. The comparative marketed product comprises water, sodium dodecylbenzenesulphonate, sodium laureth sulphate, sodium chloride, lauramidorprylamine oxide, C9-C11 pareth-8, fragrance, tertrasodium EDTA, methylisothiazolinone, methylchloroisothiazolinone, octylisothiazolinone, colorants. Further, as per the analysis of the above comparative marketed product it was observed that total solid content of concentrate was 56.28% by weight, of which anionic content was 44.64% by weight and total amphoteric content was 5.48% by weight. Hence, the ratio of anionic to amphoteric surfactants is around 8:1.

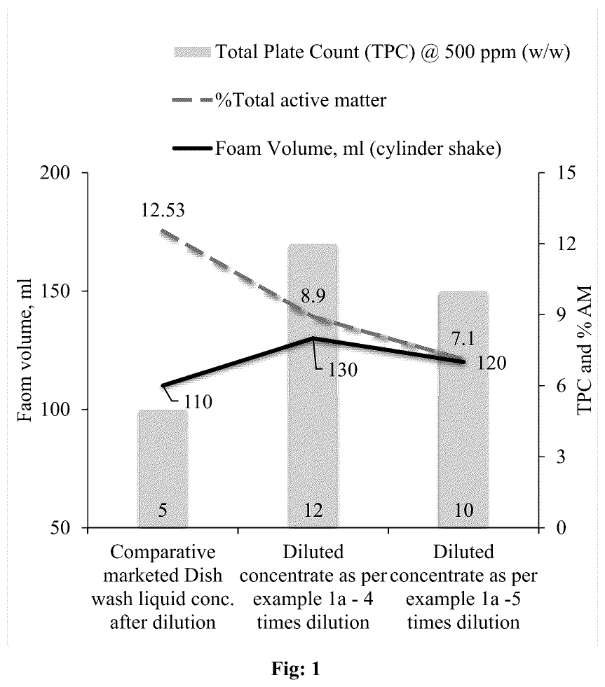

The concentrated product of present invention was diluted for 4 times and 5 times with water, while the marketed comparative product was diluted 4 times with water. Performance studies with respect to foam volume, total plate count and % active was carried out and the results are shown in FIG. 1.

It was observed that, the total plate count of 4 times diluted comparative market product is less than that of 4 times diluted composition as per present invention. Similarly, the foam volume of comparative marketed product is 110 ml and that of present invention is higher, 120 ml.

TABLE 3
Performance of composition of present invention and market product.

| | | 4 times | | 4 times |
|---|---|---|---|---|
| | Concentrate of | dilution of | Inventive | dilution of |
| Evaluation | comparative | comparative | composition | concentrate of |
| parameter | market product | market product | concentrate | present invention |
| Viscosity @ 25 | 6000 | 680 | 1278 | 10689 |
| deg. (cPs) | | | | |
| pH (As Such) | 8.0 | 8.2 | 8.32 | 8.31 |
| Solids Content, % | 56.28% | 14.07% | ~50% | ~12 to 13% |
| Total active matter | 50.12% | 12.53% | 35.5% | 8.9% |
| TPC @ 500 ppm | Not applicable | 5 | Not applicable | 12 |
| Foam volume | Not applicable | 110 | Not applicable | 130 |
| (Handshake | | | | |
| method - 300 | | | | |
| ppm hard water) | | | | |

### Example 2: Mildness Study of Composition of Present Invention

In the other embodiment, the self-thickening liquid LABSA free concentrate of the present invention, upon four times dilution is more milder and safe for hands. Comparative study is conducted with compositions as per U.S. Pat. No. 8,883,700B2 which claims the liquid dish wash composition having mildness. The composition of the present invention despite having low amount of surfactants, is high in performance and is better in terms of mildness compared to the composition of U.S. Pat. No. 8,883,700 claimed for having mildness. The mildness of dish wash formulation is essential for consumer's hands and to avoid any skin infection or skin disease due to dryness of skin with harsh chemicals.

FIG. 2 depicts the mildness of the 3 different products. The zein score of SDS was the highest making it very harsh on the hands, while the zein score of composition as per US,700 was low, this is because the composition of US'700 makes the usage of a cationic polymer/surfactant-formed coacervate. However, the composition of present invention have the zein score of 150, and is free from any usage or incorporation of cationic polymer/surfactant coacervate.

Zein powder binds to surfactant molecule and increases its dissolution. Higher the dissolution, higher the harsh effect of product. Lesser dissolution, milder effect of product.

Lower zein value means higher mild product and safe for skin. No dryness and better cleaning of utensils.

FIG. 2 demonstrates that Zein value of GSL dish wash and dish wash according to U.S. Pat. No. 8,883,700 which is claimed as mild has lower zein value and hence milder than SDS (sodium dodecyl sulfate). SDS is harsh and has shown higher zein value. Milder products safe for skin and dish wash comes in contact with skin directly, repeatedly and it can create skin diseases. So, the mildness of dish wash is highly important.

### Advantages of the Invention

1) The easily pourable, concentrated liquid compositions of the present invention are useful for avoiding significant amount of plastic that is used in packaging the home care cleanser formulations such as dish wash, surface cleanser. The concentrated form saves significant amount of water and significant saving on energy spent during processing and during transportation contribution to water conservation as well as less generation of greenhouse gases.
2) A number of home actives are added at room temperature (cold processing) to the easily pourable, concentrated liquid compositions of present the invention resulting in significant energy saving.
3) The easily pourable, hydratable, and concentrated liquid compositions of the present invention are very easy to use for the concept of ‘do-it-yourself’ wherein consumer is directed to dilute it with water and shake gently in a reusable container to form viscous, homogenous ready to use composition.
4) The concentrated, hydratable compositions of the present invention are LABSA free and offer consumer desired in-use performance in terms of superlative foam, total dish wash count and mildness to skin.

We claim:

1. A concentrated dish wash composition comprising:
a) 15% to 40% by weight of the composition, an anionic surfactant;
b) 5% to 25% by weight of the composition, at least one amphoteric surfactant;
c) 2% to 8% by weight of the composition, at least one metal salt and a preservative; and
d) 10% to 20% water,
wherein, the viscosity of the concentrated composition ranges from 1000 to 2000 mPas at temperature 25° C. which upon 4 to 6 times dilution with water increases to a range of 2500 to 10000 mPas at temperature 25° C.

2. The concentrated dish wash composition as claimed in claim 1 wherein, the anionic surfactant is selected from alkyl ethoxy ether sulfate.

3. The concentrated dish wash composition as claimed in claim 1 wherein, the anionic surfactant contains 1 to 3 moles alkyl ethoxy ether sulfate.

4. The concentrated dish wash composition as claimed in claim 1 wherein, the anionic surfactant is sodium laureth sulfate.

5. The concentrated dish wash composition as claimed in claim 1 wherein, the amphoteric surfactant comprises 10% to 20% of alkylamidopropyl betaine and 0.1% to 5% of amine oxide.

6. The concentrated dish wash composition as claimed in claim 5 wherein, the alkylamidopropyl betaine is selected from cocoamidopropyl betaine, laurylamidopropyl betaine and mixture thereof.

7. The concentrated dish wash composition as claimed in claim 5 wherein, the amine oxide is selected from lauramidopropylamine oxide, lauryl amine oxide and mixture thereof.

8. The concentrated dish wash composition as claimed in claim 1 wherein, the metal salt is divalent metal salt comprising of magnesium sulfate.

9. The concentrated dish wash composition as claimed in claim 1 wherein, weight ratio of the anionic surfactant (a) to the amphoteric surfactant (b) to is from 1:1. to 1.5:1.

10. The concentrated dish wash composition as claimed in claim 1 wherein, the said composition further comprises a hydrotrope.

11. The concentrated dish wash composition as claimed in claim 10 wherein, the hydrotrope is selected from sodium xylene sulfonate, cumene sulfonate, glycerol ethers, sodium N-octyl sulfoitaconate diester.

12. The concentrated dish wash composition as claimed in claim 1 wherein, the composition further comprises a polymer, and a humectant.

13. The concentrated dish wash composition as claimed in claim 12 wherein, the polymer is selected from acrylic polymer comprising of polyquat 7.

14. The concentrated dish wash composition as claimed in claim 12 wherein, the humectant is selected from propylene glycol, di propylene glycol, glycerine.

15. The concentrated dish wash composition as claimed in claim 1 wherein, the preservative is selected from Methylchloroisothiazolinone, phenoxyethanol, sodium benzoate, parabens.
